(19) United States
(12) Patent Application Publication
(10) Pub. No.: US 2026/0170811 A1
(43) Pub. Date: Jun. 18, 2026

(54) DEVICE AND METHOD WITH TRAINING BASED ON LANGUAGE MODEL

(71) Applicant: Samsung Electronics Co., Ltd., Suwon-si (KR)

(72) Inventor: Jaeseok CHOI, Suwon-si (KR)

(73) Assignee: Samsung Electronics Co., Ltd., Suwon-si (KR)

(21) Appl. No.: 19/237,728

(22) Filed: Jun. 13, 2025

(30) Foreign Application Priority Data
Dec. 18, 2024 (KR) 10-2024-0189938

(51) Int. Cl. G06V 10/774

(52) U.S. Cl. CPC G06V 10/7747

(57) ABSTRACT

A training method performed by one or more processors includes: generating a curriculum used to train a control model of a robot so that the robot performs a target movement skill by inputting, to a first language model, first input data including a first skill description component including the target movement skill of the robot, wherein the curriculum includes training stages including a first training stage and a second training stage; generating first reward functions used for reinforcement learning of the first training stage by inputting, to a second language model, second input data including a first training description of the first training stage that is based on or obtained from the curriculum; and performing reinforcement learning for the control model based on the first reward functions.

### CROSS-REFERENCE TO RELATED APPLICATIONS

This application claims the benefit under 35 USC § 119(a) of Korean Patent Application No. 10-2024-0189938, filed on Dec. 18, 2024, in the Korean Intellectual Property Office, the entire disclosure of which is incorporated herein by reference for all purposes.

### BACKGROUND

### 1. Field

The following description relates to a device and method with training based on a language model.

### 2. Description of Related Art

Reinforcement learning may be used for robot control. Reinforcement learning is a type of machine learning in which an agent trains to interact with an environment and maximize rewards. The agent may select an action from a current state, receive a reward as a result of the action, and move to a new state. During the training process, the agent may train an optimal policy, that is, which action to perform in which situation to maximize the reward. A generative language model may be used to generate a reward function for reinforcement learning. The generative language model is generally based on a neural network and may understand and generate language by training with text training data.

The above description is information the inventor(s) acquired during the course of conceiving the present disclosure, or already possessed at the time, and is not necessarily art publicly known before the present application was filed.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a training method performed by one or more processors includes: generating a curriculum used to train a control model of a robot so that the robot performs a target movement skill by inputting, to a first language model, first input data including a first skill description component including the target movement skill of the robot, wherein the curriculum includes training stages including a first training stage and a second training stage; generating first reward functions used for reinforcement learning of the first training stage by inputting, to a second language model, second input data including a first training description of the first training stage that is based on or obtained from the curriculum; and performing reinforcement learning for the control model based on the first reward functions.

The training method may further include: determining whether to proceed to the second training stage by executing the first language model based on a representative training result selected from among training results respectively corresponding to the first reward functions; and in response to determining to proceed to the second training stage, inputting, to the second language model, third input data including a second training description of the second training stage to generate second reward functions used for reinforcement learning of the control model with respect to the second training stage, the second training description based on or obtained from the curriculum.

The determining of whether to proceed to the second training stage may include inputting, to the first language model, the first reward function of the representative training result, a reward score of the representative training result, and a video simulation result simulating movement of the robot according to the representative training result.

The training method may further include: modifying the first training stage by executing the first language model based on a representative training result selected from among training results respectively corresponding to the first reward functions.

The first input data may further include an image component including an appearance of the robot.

Each of the training stages may include a stage description and an environment description.

Difficulty of performance may gradually increase based on the stage description and the environment description as the training stages progress from one training stage to the next.

The control model may be progressively trained based on the training stages of the curriculum.

The first input data may includes a number specifying a maximum number of stages, and the generating of the curriculum includes generating the training stages of the curriculum based on the specified maximum number of stages.

The first language model may be a vision language model, and the second language model may be a coding language model.

A non-transitory computer-readable storage medium stores instructions that, when executed by a processor, cause the processor to perform any of the methods.

In another general aspect, an electronic device includes: one or more processors; and a memory storing instructions that when executed by the one or more processors cause the electronic device to: generate a curriculum used to train a control model of a robot so that the robot performs a target movement skill by inputting, to a first language model, first input data including a first skill description component including the target movement skill of the robot, wherein the curriculum includes training stages including a first training stage and a second training stage; generate first reward functions used for reinforcement learning of the first training stage by inputting, to a second language model, second input data including a first training description of the first training stage that is based on or obtained from the curriculum; and perform reinforcement learning for the control model based on the first reward functions.

The instructions, when executed by the one or more processors, may further cause the electronic device to: determine whether to proceed to the second training stage by executing the first language model based on a representative training result selected from among training results respectively corresponding to the first reward functions; and in response to determining to proceed to the second training stage, input, to the second language model, third input data including a second training description of the second training stage to generate second reward functions used for reinforcement learning of the control model with respect to the second training stage, the second training description based on or obtained from the curriculum.

The instructions, when executed by the one or more processors, may further cause the electronic device to determine whether to proceed to the second training stage by inputting, to the first language model, the first reward function of the representative training result, a reward score of the representative training result, and a video simulation result simulating movement of the robot according to the representative training result.

The instructions, when executed by the one or more processors, may cause the electronic device to modify the first training stage by executing the first language model based on a representative training result selected from among training results respectively corresponding to the first reward functions.

The first input data may further include an image component including an appearance of the robot.

Each of the training stages may include a stage description and an environment description, and difficulty of performance gradually increases based on the stage description and the environment description as the training stages progress from one training stage to the next.

The control model may be progressively trained based on the training stages of the curriculum.

The first input data may include a number specifying a maximum number of stages, and the instructions, when executed by the one or more processors, cause the electronic device to generate the curriculum by generating the training stages of the curriculum based on the specified maximum number of stages.

The first language model may be a vision language model, and the second language model may be a coding language model.

Other features and aspects will be apparent from the following detailed description, the drawings, and the claims.

### BRIEF DESCRIPTION OF THE DRAWINGS

FIG. 1 illustrates an example of a reinforcement learning process using language models, according to one or more embodiments.

FIG. 2 illustrates an example of a curriculum generation operation of a first language model, according to one or more embodiments.

FIG. 3 illustrates an example of a curriculum configuration, according to one or more embodiments.

FIG. 4 illustrates an example of a reinforcement learning process based on output of a second language model, according to one or more embodiments.

FIG. 5 illustrates an example of a feedback generation operation and a current stage determination operation of a first language model.

FIG. 6 illustrates an example of a configuration of a robot, according to one or more embodiments.

FIG. 7 illustrates an example of a configuration of an electronic device, according to one or more embodiments.

FIG. 8 illustrates an example of a cooperative operation of an electronic device and an extended device, according to one or more embodiments.

FIG. 9 illustrates an example of a training method, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

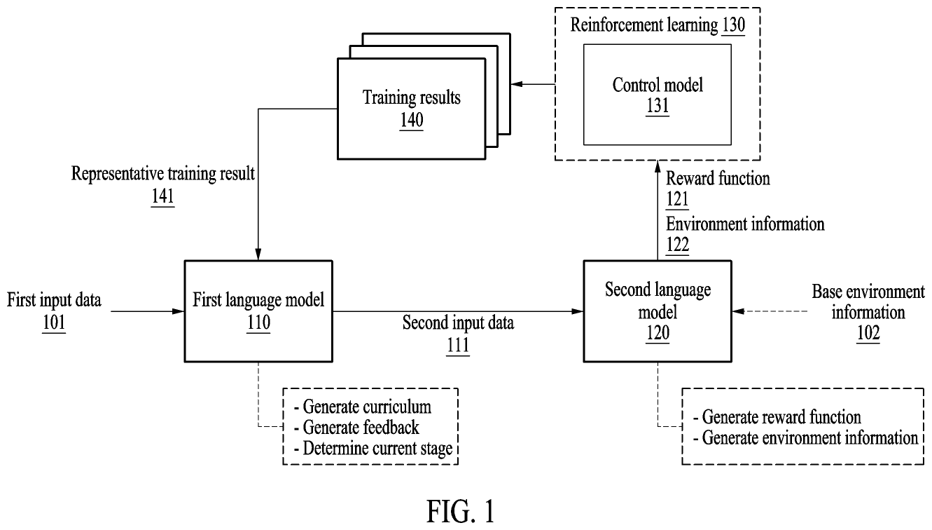

FIG. 1 illustrates an example of a reinforcement learning process using language models, according to one or more embodiments. Referring to FIG. 1, a first language model 110 may perform curriculum generation, feedback generation, and current stage determination. A curriculum may be generated by inputting first input data 101 to the first language model 110. The first input data 101 may include a first skill description component including a target movement skill of a robot.

For example, the robot may include various types of robotics systems, such as humanoid robots, quadruped walking robots, transport robots, stationary robots, and drones. However, examples are not limited thereto. A movement skill may include various movements, such as walking, running, driving, catching, throwing, and carrying. However, examples are not limited thereto. The robot may perform the movement skill using a control model of the robot. The control model may be a neural network model.

Generally speaking, curriculum learning may involve designing tasks to guide the learning process of a network or agent. This can be useful to bootstrap the network for hard problems and may better achieve convergence. The generated curriculum may be used to train the control model of the robot. The curriculum may be used to train the control model so that the robot performs the target movement skill among various movement skills that the robot is capable of performing, thus increasing the control model's understanding of the target movement skill. The curriculum may include training stages. The control model may be progressively trained based on the training stages of the curriculum. The first language model 110 may generate the curriculum, which is then used to gradually train the target movement skill through the training stages.

The control model may sequentially train the movement skills from an easy movement skill to a difficult movement skill according to the curriculum and then may finally train the target movement skill. In a process of training the target movement skill, the movement skill trained at each training stage may be referred to as a partial movement skill (“partial” in the sense of being a part or component of the compound target movement skill). For example, a the target movement skill may be set to be a movement of running at a target speed while avoiding an obstacle. In this case, the partial movement skills may be maintaining balance, running at the target speed, and avoiding the obstacle. The control model may first be trained for the first partial movement skill (maintaining balance through a first training stage), may then be trained for the second partial movement skill (running at the target speed) through a second training stage, and may then be trained for the third partial movement skill (avoiding the obstacle) through a third training stage. The control model may then be trained for the target movement skill by training the first partial movement skill to the third partial movement skill. The first training stage to the third training stage may be performed sequentially, that is, one stage after another.

In iterating through the training stages, the first language model 110 may output a training description of a current training stage among the curriculum's training stages. Second input data 111 may be determined based on the output of the first language model 110. The second input data 111 may include the training description of the current training stage. For example, the second input data 111 may initially include a first training description of the first training stage. The training description of the current training stage may include an indication of the partial movement skill of the current training stage. The training description of the current training stage may further include an environment description. The environment description is described below.

A reward function 121 and/or environment information 122 may be generated by inputting the second input data 111 into a second language model 120, which generates/infers the reward function 121 and/or the environment information 122 based on the second input data 111 and/or base environment information 102. The reward function 121 and/or the environment information 122 may then be used for reinforcement learning 130 of the current training stage (e.g., the first training stage) of a control model 131.

The base environment information 102 may represent a simulation environment (e.g., a 2D or 3D virtual space). For example, the base environment information 102 may include robot information and/or surrounding environment information. For example, the robot information may include information about robot type, state, position, speed, actuators (e.g., motors), shape/size (e.g., a 2D or 3D model) and joints. However, examples are not limited thereto. The surrounding environment information may include information about terrain and obstacles. However, examples are not limited thereto. The surrounding environment information may correspond to environment code.

The reinforcement learning 130 may be performed on the control model 131 based on the reward function 121 and/or the environment information 122. The reinforcement learning 130 is a type of machine learning in which an agent interacts with an environment and trains to maximize a reward. The agent may select an action from a current state, may receive the reward as a result of the action, and may move to a new state. During the training process, the agent may train an optimal policy, that is, which action to perform in which situation to maximize the reward. The agent may correspond to the control model 131 and/or the robot.

Training results 140 may be generated according to the reinforcement learning 130. The second language model 120 may generate samples, each including its own reward function 121 and environment information 122. The reinforcement learning 130 may be performed based on the samples to generate the training results 140. The training results 140 may correspond to the samples, respectively.

Each training result of the training results 140 may include a corresponding reward function 121 (of the that sample) and a reward score (of that sample). A representative training result 141 may be selected from the training results 140. Among the training results 140, an optimal training result may be selected as the representative training result 141. For example, a training result with the highest reward score may be selected as the representative training result 141, but examples are not limited thereto.

The first language model 110 may perform a feedback generation operation and a current stage determination operation based on the representative training result 141. When the current stage determination operation indicates that the representative training result 141 satisfies a goal of the current training stage (e.g., the first partial movement skill of the first training stage), the first language model 110 may proceed to the next training stage of the curriculum. When the representative training result 141 does not satisfy the goal of the current training stage, the first language model 110 may generate feedback to modify the current training stage.

More specifically, based on the representative training result 141 selected from the training results 140, the first language model 110 may be performed to determine whether to proceed to the next training stage (e.g., the second training stage) among the training stages of the curriculum. When it is determined to proceed to the next training stage, next second input data 111 including a training description of the next training stage may be input into the second language model 120 to generate the next samples of the reward function 121 and/or the environment information 122 used for the reinforcement learning 130 of the next training stage of the curriculum.

When it is determined not to proceed to the next training stage, the current training stage may be modified by executing the first language model 110 based on the representative training result 141 selected from the training results 140. For example, a requirement may be added to the current training stage to achieve the goal of the current training stage (e.g., the first partial movement skill of the first training stage). In this case, the second language model 120 may be re-executed based on the second input data 111 including a training description of the modified current training stage.

According to an example, the first language model 110 and the second language model 120 may be generative language models. A generative language model is a model based on a neural network that may understand and generate language by training on training text data. For example, the generative language model may be a large language model (LLM).

According to an example, the first language model 110 may be a vision language model. The second language model 120 may be a coding language model. The vision language model may be an LLM trained to understand vision. The coding language model may be an LLM trained to generate code.

According to an example, the first language model 110 may be multi-modal and may additionally receive image input in addition to text input. For example, the first input data 101 may include a skill description component including the target movement skill of the robot and an image component including an appearance of the robot. For example, the image component may include visual information about the appearance of the robot and/or a surrounding environment of the robot. The first language model 110 may generate a more effective curriculum by using the skill description component and the image component together compared to when only the skill description component is used.

According to an example, the first language model 110 may determine whether to proceed to the next training stage (e.g., the second training stage) based on the reward function 121 of the representative training result 141, the reward score of the representative training result 141, and a video simulation result for movement of the robot according to the representative training result 141 (e.g., from a 3D virtual reality simulator or the like). There may be a control model 131 corresponding to each training result of the training results 140 (each training result 140 may have its own control model). The video simulation result may be generated by simulating the movement of the robot based on the control model 131 in an environment of each training stage or in an arbitrary environment. For example, a physics engine may be used for a visual simulation. The first language model 110 may more accurately evaluate the representative training result 141 by using text information (e.g., the reward function 121 and the reward score) and the video simulation result together, as compared to when only the text information is used.

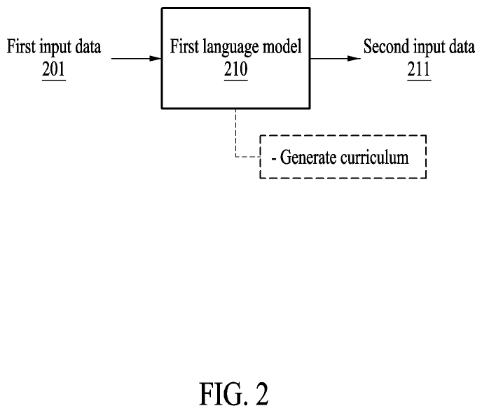

FIG. 2 illustrates an example of a curriculum generation operation of a first language model, according to one or more embodiments. Referring to FIG. 2, the first language model 210 may generate a curriculum based on first input data 201. Second input data 211 may be determined based on a current training stage of the curriculum. For example, for multiple training stages, each training stage may include its own stage description and/or an environment description, and the second input data 211 of the current training stage may include the stage description and/or the environment description of the current stage.

The first input data 201 may include an image component and a text component. The image component may represent an initial scene of a robot. The initial scene may include an appearance of the robot and a surrounding environment of the robot at an initial moment when the robot is about to perform a target movement skill. The text component may include a skill description component including the target movement skill of the robot.

According to an example, the first input data 201 may include a system prompt and a user prompt. For example, the system prompt may include role assignments, definition of a curriculum generation process, an example of an output format of the curriculum generation process, and/or cautions regarding curriculum generation. The user prompt may include the skill description and/or the initial scene. Table 1 below shows an example of the first input data 201, but the first input data 201 is not limited to this example. For convenience, the image component (e.g., the initial scene) is omitted in Table 1.

```
TABLE 1
  System Prompt:
  You are a reinforcement learning expert aiding a coding LLM agent that generates
reward function code based on task descriptions. Your task is to design a curriculum that allows
the agent to learn progressively, ensuring stable and successful performance. Structure the
curriculum in up to 3 stages, and if a task can be learned in a single stage due to its simplicity,
create it as a 1-stage curriculum. There are separate agents for creating the reward function code
and the environment manipulation code, so your role is to provide detailed explanations in a
single paragraph without writing the code yourself.
  # Steps
  1. **Analyze the Initial State:** Describe the current capabilities of the robot and the
environment it operates in.
  2. **Stage 1 - Basic Skills Development:** Define initial skill(s) the robot should
acquire to create a foundation for more complex tasks.
  3. **Stage 2 - Intermediate Skills Enhancement:** Identify additional skill(s) that
leverage the robot's basic abilities while introducing new challenges.
  4. **Stage 3 - Advanced Skill Mastery:** Focus on complex skills that require full
utilization of previously learned behaviors and adaptations to unexpected events or challenges.
  # Output Format
  Stage 1 (Reward function): Make the robot be a quadrupedal robot capable of walking.
  Stage 1 (Environment): Make the surface flat to learn basic locomotion.
  Stage 2 (Reward function): Make the quadrupedal robot capable of overcoming
obstacles.
  Stage 2 (Environment): Place obstacles in a zigzag pattern at 1-meter intervals along
the path to develop the robot's obstacle avoidance capability.
  # Notes
  - Ensure each stage represents a natural progression in skill complexity.
  - Consider safety constraints and efficiency improvements in your curriculum design.
  - The initial state will be provided with an image. Create a curriculum suitable for the
initial environment.
  User Prompt:
  Make a curriculum for the following task:
  Make the go1 quadruped run at exactly 2.0 m/s while avoiding obstacles.
  Initial state: [an image of the initial scene]
```

The first language model 210 may generate the curriculum with a schedule of various training stages according to difficulty of performance. The number of stages may be limited. For example, the first input data 201 may specify the maximum number of stages, and the training stages of the curriculum may be generated based on the maximum number of stages. The description for each training stage may include the stage description and/or the environment description thereof. The stage description and/or the environment description may have a natural language paragraph format. The curriculum may start with an initial training stage (e.g., a first training stage).

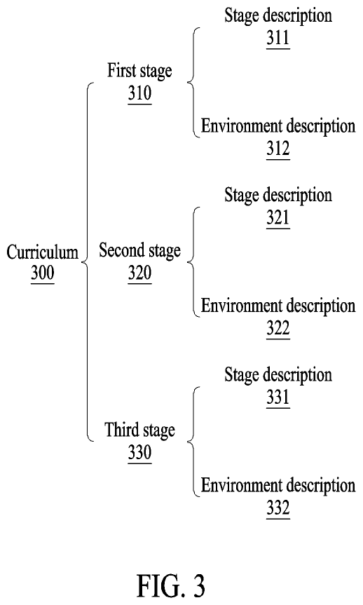

FIG. 3 illustrates an example of a curriculum configuration, according to one or more embodiments. Referring to FIG. 3, a curriculum 300 may include a first stage 310, a second stage 320, and a third stage 330. Each of the first stage 310, the second stage 320, and the third stage 330 may be a training stage. The first to third stages 310 to 330 may each include stage descriptions 311 to 331 and environment descriptions 312 to 332. The first stage 310 may include a stage description 311 and an environment description 312. The second stage 320 may include a stage description 321 and an environment description 322. The third stage 330 may include a stage description 331 and an environment description 332.

As the first to third stages 310 to 330 proceed, difficulty of performance may gradually increase based on the stage descriptions 311 to 331 and the environment descriptions 312 to 332. Table 2 below shows an example of the curriculum 300, but the example is not limited thereto.

TABLE 2
Stage 1 (Reward function): Design a reward function centered on achieving stable
forward locomotion. It should reward the go1 quadruped for moving in the positive x direction
and maintaining a velocity close to 2.0 m/s. Additional rewards should be given for consistent
motion and penalizing high variation in speed. Include terms that promote smooth leg
movements and penalize excessive action rates to encourage efficiency.
Stage 1 (Environment): Begin with a flat, obstacle-free environment. This setting
allows the quadruped to focus solely on mastering the desired running speed without dealing
with additional complexities from the surroundings. Stability and consistent speed control are
the primary targets in this stage.
Stage 2 (Reward function): Enhance the reward function to emphasize precise velocity
control, ensuring the quadruped consistently achieves exactly 2.0 m/s. Continue to reward
smooth and efficient leg movements while including penalties for harsh actions and deviations
from desired speed. This function should also start to include minor incentives for preliminary
efforts at obstacle avoidance.
Stage 2 (Environment): Introduce simple obstacles such as low barriers or small gaps
at intervals along the path. These obstacles should be sparse enough not to overwhelm the
quadruped but should encourage the development of basic obstacle avoidance behaviors while
maintaining target speed.
Stage 3 (Reward function): Refine the reward function further to prioritize not only
maintaining the exact speed of 2.0 m/s but also effectively avoiding obstacles. Significant
rewards should be allocated for smooth navigation around obstacles with minimal disruption to
speed and motion efficiency. Closely monitor and penalize any actions that lead to collisions or
severe deviations.
Stage 3 (Environment): Increase the density and complexity of obstacles. Options
might include varied heights of barriers, different widths of gaps, and non-uniform patterns.
These added challenges are designed to test and enhance the quadruped's ability to maintain the
desired running speed while dynamically navigating an increasingly complex terrain, thus
preparing it for real-world deployment scenarios.

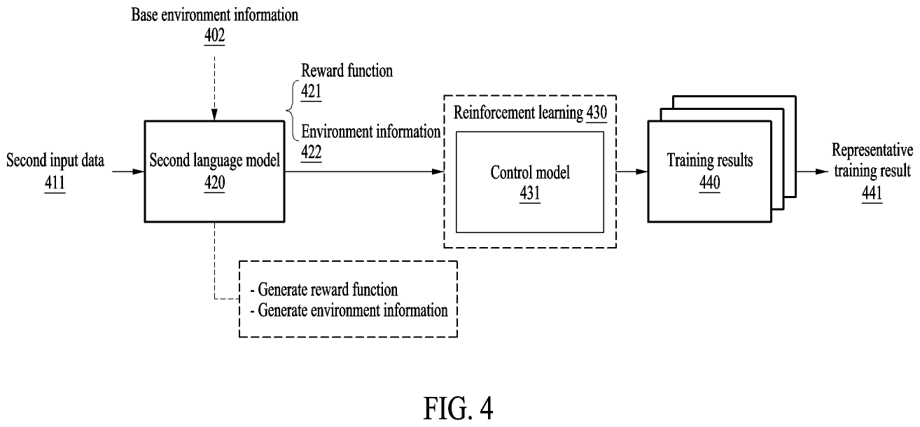

FIG. 4 illustrates an example of a reinforcement learning process based on output of a second language model, according to one or more embodiments. Referring to FIG. 4, a second language model 420 may generate a reward function 421 and/or environment information 422 based on second input data 411 and/or base environment information 402. The second input data 411 may include a stage description and/or an environment description of a current training stage. The base environment information 402 may represent a simulation environment (for example, aspects of the environment that are expected to remain constant for the different training stages, for example walls). The second language model 420 may generate the reward function 421 based on the stage description and/or the base environment information 402. The second language model 420 may generate the environment information 422 based on the environment description and/or the base environment information 402.

The reward function 421 may be generated in the form of a function. The reward function 421 may be generated to correspond to the grammar of current code in an executable manner (e.g., in the form of executable source code). The environment information 422 may be environment code. The environment code may be generated at the level of changing numerical values (e.g., of parameters of the environment) or adding objects within a provided code format (e.g., a 3D model of an object). Reinforcement learning 430 of a control model 431 may be performed by sampling multiple pairs of reward functions and environment codes. Training results 440 may be generated according to the reinforcement learning 430. A training result that is evaluated as the best performance of a provided task (e.g., a partial movement skill of the current stage) may be selected as a representative training result 441. A video simulation result regarding the representative training result 441 may be generated.

According to an example, the second input data 411 may include a system prompt and a user prompt. The stage description and/or the environment description of the current training stage may be included in the user prompt, but examples are not limited thereto.

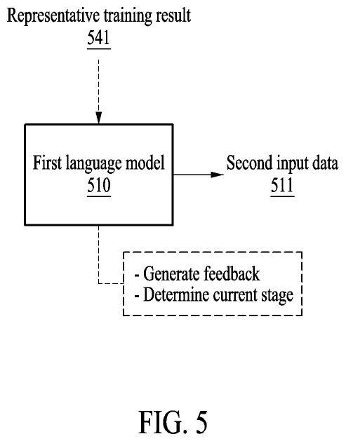

FIG. 5 illustrates an example of a feedback generation operation and a current stage determination operation of a first language model, according to one or more embodiments. Referring to FIG. 5, a first language model 510 may perform feedback generation and current stage determination based on a representative training result 541. A video simulation result regarding the representative training result 541 may be generated. The first language model 510 may perform the feedback generation and the current stage determination based on a reward function used to derive the representative training result 541, a reward score according to the reward function, and the video simulation result.

The first language model 510 may visually confirm task performability of a robot during a process of the feedback generation and may evaluate whether the robot performs a task of a current training stage properly. The first language model 510 may evaluate the task performance ability by referring to the reward score. The first language model 510 may modify a stage description so as to supplement deficiencies in the reward function of the representative training result 541.

When the first language model 510 determines that the task performability of the robot for the current training stage is sufficient, the first language model 510 may proceed to a next training stage. In the next training stage, the reward function may be generated using a second language model, and the feedback generation and the current stage determination regarding the next training stage may be performed based on training results of the next training stage. The feedback generation and the current stage determination may be performed repeatedly until a final training stage is completed.

Input data of the first language model 510 may be determined based on the representative training result 541. According to an example, the input data may include a system prompt and a user prompt. For example, the system prompt may include one or more of role assignments, definition of feedback generation and stage selection processes, an example of an output format of the feedback generation and stage selection processes, and cautions regarding feedback generation and stage selection. The user prompt may include a curriculum description (e.g., a goal of the curriculum, a description of each training stage), identification information of the current training stage, the reward function and the reward score of the representative training result 541, and/or the video simulation result of the representative training result 541. Table 3 below shows an example of the input data of the first language model 510 for the feedback generation and the current stage determination, but the example is not limited thereto. For convenience, the video simulation result is omitted in Table 3.

```
TABLE 3
  System prompt:
  Evaluate the intermediate results of reinforcement learning in robot movement to
determine readiness to advance to the next stage in its training curriculum. When provided with
a video and a description of the current curriculum stage, decide if the robot's movements are
natural and efficient enough to progress, allowing for some flexibility in judgment.
  # Steps
  1. **Examine the Curriculum Stage:**
  - Review the description of the current stage of training to understand the specific
objectives and expected behaviors for the robot.
  2. **Analyze the Video:**
  - Watch the provided footage of the robot's movements during the mentioned stage.
  - Look for indicators of natural movement, such as fluid transitions, and efficient
locomotion.
  3. **Evaluate Performance:**
  - Compare the robot's performance in the video to the expectations of the current stage.
  - Consider any anomalies or improvements needed in the robot's movements.
  4. **Decide Readiness:**
  - Use a flexible approach to judge whether the robot meets the criteria to move to the
next stage.
  - Consider any minor discrepancies that can be improved in subsequent training stages.
  # Output Format
  Provide a recommendation in a short paragraph and a stage selection result. Describe
whether the robot should advance to the next stage, stay in the current stage for further training,
and specify any particular strengths or weaknesses observed in the robot's movement.
  # Examples
  **Output:**
  - Feedback: The robot demonstrates [specific strength, e.g., fluid movement] and
[specific weakness, e.g., occasionally hesitates during turns]. Given these observations and the
expectations of the current stage, it is [ready or not ready] to move to the next stage of training,
with [potential improvements noted for future training].
  - “Stage selection result: [Move to Stage X / Stay in Stage X]”
  # Notes
  - Apply flexibility in judgment to minor imperfections if they do not impede overall
progress.
  - Take into account possible edge cases where movements may be hindered by factors
not immediately apparent in the video.
  - The stage selection result MUST BE PROVIDED following the provided example
format.
  - The stage selection can only result in either advancing to the next stage or staying in
the current stage for further training. Returning to a previous stage is not an option.
  User prompt:
  Curriculum Description:
  - Main goal: To make the go1 quadruped run forward with a velocity of exactly 2.0
m/s ...
  - Stage 1: Develop the fundamental locomotion skills for the go1 quadruped to walk
forward steadily. ...
  - Stage 2: Refine the locomotion to achieve a forward running speed of exactly 2.0 m/s
in the positive x direction.
  Current Stage: 1
  Reward function: [Best reward function code]
  Scores: [Best training results]
  Video Clip: [Best video footage]
```

Table 4 below shows an example of output regarding the feedback generation and the current stage determination of the first language model 510, but the example is not limited thereto. A current stage may be determined based on feedback. The next training stage may be proceeded-to based on the current stage determination.

TABLE 4
Feedback: The robot displays the ability to move at varying speeds,
even exceeding 2.0 m/s; however, it lacks stability and control, as
indicated by the significant yaw deviations from the ideal orientation.
The torso height is inconsistent, often dropping below the target of
0.34 m, compromising balance. The motion exhibits some abruptness,
particularly at higher speeds, which is not suitable for progression
to the next stage where increased speed and control are emphasized.
The current performance does not align with the expectations for Stage 1
regarding smooth transitions and maintaining stable postures.
Stage selection results: Stay in Stage 1

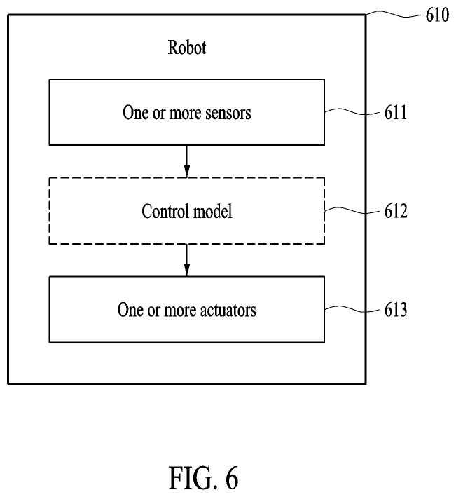

FIG. 6 illustrates an example of a configuration of a robot, according to one or more embodiments. Referring to FIG. 6, a robot 610 may include one or more sensors 611, a control model 612, and one or more actuators 613. For example, the one or more sensors 611 may include a vision sensor (e.g., a camera), a range sensor (e.g., a radar sensor, a light detection and ranging (LiDAR) sensor, and/or an ultrasonic sensor), an auditory sensor, an inertial sensor, a tactile sensor, a temperature sensor, a position sensor, a biometric sensor, and/or the like. However, examples are not limited thereto. Sensor output may be generated from the one or more sensors 611. The control model 612 may control the robot 610 based on the sensor output. For example, the control model 612 may control the one or more actuators 613. The one or more actuators 613 may move the robot 610 through a drive system such as a joint. For example, the one or more actuators 613 may include a motor but are not limited thereto.

The control model 612 may be a neural network model. The control model 612 may include network parameters trained through reinforcement learning according to an example. The control model 612 may generate an appropriate movement according to the sensor output using the network parameters. For example, the control model 612 may generate a movement to implement a target movement skill based on the sensor output from various environments.

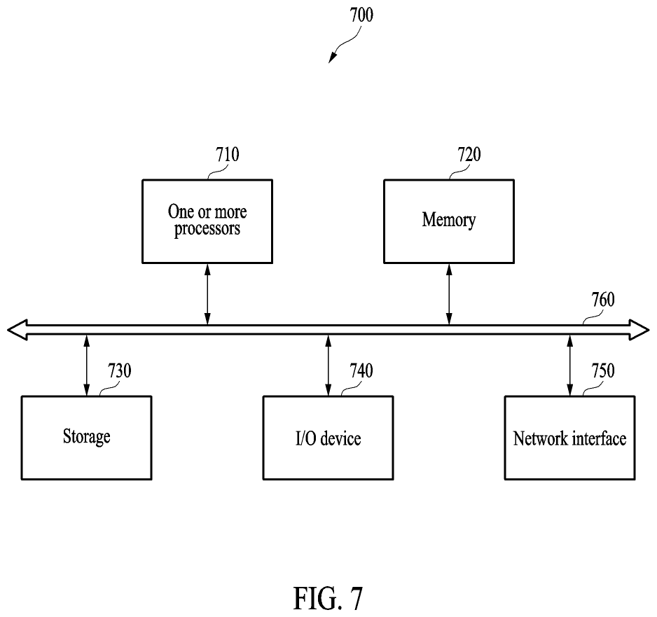

FIG. 7 illustrates an example of a configuration of an electronic device, according to one or more embodiments. Referring to FIG. 7, an electronic device 700 may include one or more processors 710, a memory 720, a storage 730, an input/output (I/O) device 740, and a network interface 750. These components may communicate with each other via a communication bus 760. For example, the electronic device 700 may be implemented as at least a portion of, for example, a mobile device such as a mobile phone, a smartphone, a personal digital assistant (PDA), a netbook, a tablet computer, and a laptop computer, a wearable device such as a smartwatch, a smart band, and smart glasses, or a computing device such as a desktop and a server.

The one or more processors 710 may execute instructions stored in the memory 720 or the storage 730. When executed by the one or more processors 710, the instructions may cause the electronic device 700 to perform the operations described with reference to FIGS. 1 to 6 and FIG. 8. The memory 720 may include a non-transitory computer-readable storage medium or a non-transitory computer-readable storage device. The memory 720 may store instructions to be executed by the one or more processors 710 and may store related information while software and/or an application is being executed by the electronic device 700.

The storage 730 may include a computer-readable storage medium or a computer-readable storage device. The storage 730 may store a more quantity of information than the memory 720 for a long time. For example, the storage 730 may include a magnetic hard disk, an optical disc, a flash memory, a floppy disk, or other non-volatile memories known in the art.

The I/O device 740 may receive an input from the user in traditional input manners through a keyboard and a mouse, and in new input manners, such as a touch input, a voice input, and an image input. For example, the I/O device 740 may include a keyboard, a mouse, a touch screen, a microphone, or any other device that detects the input from the user and transmits the detected input to the electronic device 700. The I/O device 740 may provide an output of the electronic device 700 to the user through a visual, auditory, or haptic channel. The I/O device 740 may include, for example, a display, a touch screen, a speaker, a vibration generator, or any other device that provides the output to the user. The network interface 750 may communicate with an external device through a wired or wireless network.

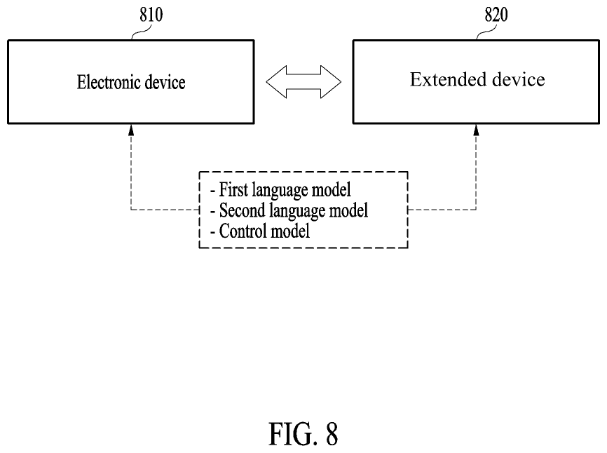

FIG. 8 illustrates an example of a cooperative operation of an electronic device and an extended device, according to one or more embodiments. Referring to FIG. 8, an electronic device 810 and/or an extended device 820 may store a first language model, a second language model, and a control model. According to an example, the electronic device 810 may store the control model, the first language model, and the second language model but is not limited thereto. In this case, the electronic device 810 may perform curriculum generation, feedback generation, and current stage determination using the first language model of the electronic device 810 and may perform reinforcement learning of the control model using the second language model of the electronic device 810.

According to an example, the electronic device 810 may store the control model, and the extended device 820 may store the first language model and the second language model, but examples are not limited thereto. In this case, the electronic device 810 may perform curriculum generation, feedback generation, and current stage determination using the first language model of the extended device 820 and may perform reinforcement learning of the control model using the second language model of the extended device 820. For example, the extended device 820 may provide an application programming interface (API) for utilizing the first language model and/or the second language model, and the electronic device 810 may access the first language model and the second language model using the API.

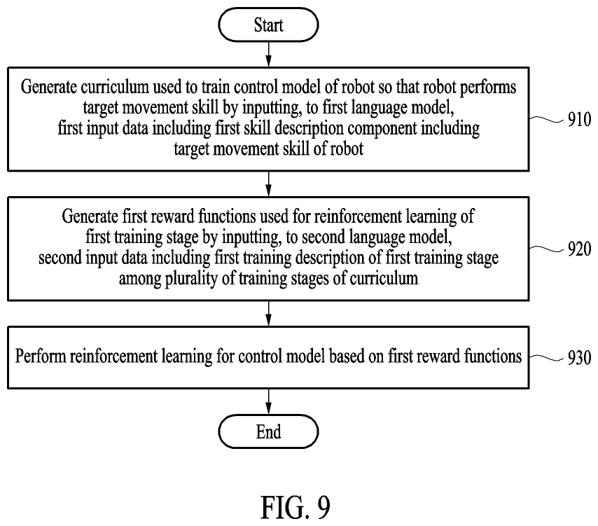

FIG. 9 illustrates an example of a training method, according to one or more embodiments. Referring to FIG. 9, in operation 910, an electronic device (e.g., the electronic device 810) may generate a curriculum used to train a control model of a robot so that the robot performs a target movement skill by inputting, to a first language model, first input data including a first skill description component including the target movement skill of the robot. In operation 920, the electronic device may generate first reward functions used for reinforcement learning of a first training stage by inputting, to a second language model, second input data including a first training description of the first training stage among a plurality of training stages of the curriculum. In operation 930, the electronic device may perform the reinforcement learning for the control model based on the first reward functions.

The electronic device may determine whether to proceed to a second training stage among the training stages by executing the first language model based on a representative training result selected from training results corresponding to the first reward functions and in response to determining to proceed to the second training stage, may input, to the second language model, third input data including a second training description of the second training stage to generate second reward functions used for reinforcement learning of the second training stage.

The determining of whether to proceed to the second training stage may include inputting, to the first language model, a first reward function of the representative training result, a reward score of the representative training result, and a video simulation result for movement of the robot according to the representative training result.

The electronic device may modify the first training stage by executing the first language model based on a representative training result selected from training results corresponding to the first reward functions.

The first input data may further include an image component including an appearance of the robot.

Each of the training stages may include a stage description and an environment description. Difficulty of performance may gradually increase based on the stage description and the environment description with progression through the training stages.

The control model may be progressively trained based on the training stages of the curriculum.

The first input data may include the maximum number of stages, and operation 910 may include generating the training stages of the curriculum based on the maximum number of stages.

The first language model may be a vision language model, and the second language model may be a coding language model.

The computing apparatuses, the robots, the electronic devices, the processors, the memories, the sensors, the information output system and hardware, the storage devices, and other apparatuses, devices, units, modules, and components described herein with respect to FIGS. 1-9 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-9 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A training method performed by one or more processors, the training method comprising:
generating a curriculum used to train a control model of a robot so that the robot performs a target movement skill by inputting, to a first language model, first input data including a first skill description component including the target movement skill of the robot, wherein the curriculum comprises training stages including a first training stage and a second training stage;
generating first reward functions used for reinforcement learning of the first training stage by inputting, to a second language model, second input data including a first training description of the first training stage that is based on or obtained from the curriculum; and
performing reinforcement learning for the control model based on the first reward functions.

2. The training method of claim 1, further comprising:
determining whether to proceed to the second training stage by executing the first language model based on a representative training result selected from among training results respectively corresponding to the first reward functions; and
in response to determining to proceed to the second training stage, inputting, to the second language model, third input data including a second training description of the second training stage to generate second reward functions used for reinforcement learning of the control model with respect to the second training stage, the second training description based on or obtained from the curriculum.

3. The training method of claim 2, wherein
the determining of whether to proceed to the second training stage comprises inputting, to the first language model, the first reward function of the representative training result, a reward score of the representative training result, and a video simulation result simulating movement of the robot according to the representative training result.

4. The training method of claim 1, further comprising:
modifying the first training stage by executing the first language model based on a representative training result selected from among training results respectively corresponding to the first reward functions.

5. The training method of claim 1, wherein
the first input data further comprises an image component including an appearance of the robot.

6. The training method of claim 1, wherein
each of the training stages comprises a stage description and an environment description.

7. The training method of claim 6, wherein
difficulty of performance gradually increases based on the stage description and the environment description as the training stages progress from one training stage to the next.

8. The training method of claim 1, wherein
the control model is progressively trained based on the training stages of the curriculum.

9. The training method of claim 1, wherein
the first input data comprises a number specifying a maximum number of stages, and
the generating of the curriculum comprises generating the training stages of the curriculum based on the specified maximum number of stages.

10. The training method of claim 1, wherein
the first language model is a vision language model, and
the second language model is a coding language model.

11. A non-transitory computer-readable storage medium storing instructions that, when executed by a processor, cause the processor to perform the training method of claim 1.

12. An electronic device comprising:
one or more processors; and
a memory storing instructions that when executed by the one or more processors cause the electronic device to:
generate a curriculum used to train a control model of a robot so that the robot performs a target movement skill by inputting, to a first language model, first input data including a first skill description component including the target movement skill of the robot, wherein the curriculum comprises training stages including a first training stage and a second training stage;
generate first reward functions used for reinforcement learning of the first training stage by inputting, to a second language model, second input data including a first training description of the first training stage that is based on or obtained from the curriculum; and
perform reinforcement learning for the control model based on the first reward functions.

13. The electronic device of claim 12, wherein
the instructions, when executed by the one or more processors, further cause the electronic device to:
determine whether to proceed to the second training stage by executing the first language model based on a representative training result selected from among training results respectively corresponding to the first reward functions; and
in response to determining to proceed to the second training stage, input, to the second language model, third input data including a second training description of the second training stage to generate second reward functions used for reinforcement learning of the control model with respect to the second training stage, the second training description based on or obtained from the curriculum.

14. The electronic device of claim 13, wherein
the instructions, when executed by the one or more processors, cause the electronic device to determine whether to proceed to the second training stage by inputting, to the first language model, the first reward function of the representative training result, a reward score of the representative training result, and a video simulation result simulating movement of the robot according to the representative training result.

15. The electronic device of claim 12, wherein
the instructions, when executed by the one or more processors, cause the electronic device to modify the first training stage by executing the first language model based on a representative training result selected from among training results respectively corresponding to the first reward functions.

16. The electronic device of claim 12, wherein
the first input data further comprises an image component including an appearance of the robot.

17. The electronic device of claim 12, wherein
each of the training stages comprises a stage description and an environment description, and
difficulty of performance gradually increases based on the stage description and the environment description as the training stages progress from one training stage to the next.

18. The electronic device of claim 12, wherein
the control model is progressively trained based on the training stages of the curriculum.

19. The electronic device of claim 12, wherein
the first input data comprises a number specifying a maximum number of stages, and
the instructions, when executed by the one or more processors, cause the electronic device to generate the curriculum by generating the training stages of the curriculum based on the specified maximum number of stages.

20. The electronic device of claim 12, wherein
the first language model is a vision language model, and
the second language model is a coding language model.
